(19) United States
(12) Patent Application Publication
(10) Pub. No.: US 2026/0233582 A1
(43) Pub. Date: Aug. 13, 2026

(54) DOCK FAN ASSEMBLY

(71) Applicant: Hunter Fan Company, Memphis, TN (US)

(72) Inventors: Daniel Rice, Thompson's Station, TN (US); Thach Du, Nashville, TN (US); Dwayne Peyton, Antoich, TN (US); Monica Moreno, Nashville, TN (US); Mina Messiha, Nashville, TN (US)

(21) Appl. No.: 19/447,083

(22) Filed: Jan. 13, 2026

Related U.S. Application Data
(60) Provisional application No. 63/757,586, filed on Feb. 12, 2025.

(51) Int. Cl. B60H 1/24; F21V 33/00; G08B 5/36

(52) U.S. Cl. CPC B60H 1/241; F21V 33/0096; G08B 5/36

(57) ABSTRACT

A dock fan assembly for exchanging air from a trailer, having a trailer door opening, located at a dock having a dock door opening, which is aligned with the trailer door opening. The dock fan assembly has at least one fan that forms a circulation air flow path by flowing ambient air into the trailer opening to affect an exchange of ambient air for the trailer air. The duration of the flow can be a function of time and/or temperature. The completion of the air exchange can be indicated. More than one fan may be used. In one arrangement, a first fan can flow air into the trailer opening while a second fan can withdraw air from the trailer opening.

### FIELD OF THE INVENTION

This disclosure relates to the field of dock fan assemblies for flowing ambient air into a trailer during the loading and unloading of the trailer at a dock.

### BRIEF DESCRIPTION

In one aspect, this description generally relates to a method for exchanging air from a trailer, having a trailer door opening, located at a dock having a dock door opening, which is aligned with the trailer door opening, the method comprising: forming a circulation air flow path by flowing ambient air into the trailer opening with a first fan and withdrawing air from the trailer opening with a second fan; and ceasing the flowing of ambient air and the withdrawing of trailer air upon the determination that the trailer air has been exchanged with ambient air.

In another aspect, this description generally relates to a dock fan assembly for flowing ambient air to a trailer door opening located adjacent a dock door opening to exchange the trailer air with ambient air, the dock fan assembly comprising: a fan flowing ambient air into the trailer door opening; and an indicator indicating when the exchange of air is complete.

In yet another aspect, the description generally relates to a dock fan assembly for flowing ambient air to a trailer door opening located adjacent a dock door opening to exchange the trailer air with ambient air, the dock fan assembly comprising: a control box having a housing, which defines an interior; an arm movably mounted to the control box for movement between a retracted position and an extended position; a drive coupled to the arm and driving the arm between the retracted position and the extended position; a fan carried by the arm; at least one sensor carried by the arm; at least one indicator carried by the arm; and a controller located in the interior and operably coupled to the drive, fan, sensor, and indicator.

### BRIEF DESCRIPTION OF THE DRAWINGS

In the drawings:

FIG. 1 is a schematic representation of an exemplary semi-trailer at a loading dock for loading and unloading of the semi-trailer.

FIG. 2 is a schematic illustrating common semi-trailer dimensions.

FIG. 3 is a schematic illustrating the standard spatial relationships between the trailer door, dock door, and a forklift, which define the environment for the dock fan assembly.

FIG. 4 is a schematic illustrating various possible locations for a fan of the dock fan assembly.

FIG. 5 is a schematic illustrating an exemplary dock fan assembly.

FIG. 6 is a schematic illustrating an exemplary fan for the dock fan assembly.

FIG. 7 is a schematic illustrating another exemplary fan for the dock fan assembly.

FIG. 8 is a table illustrating data for the exchange of air within a trailer.

FIG. 9 is a exemplary control system block diagram.

### DETAILED DESCRIPTION

In contemporary economies, all sorts of goods are transported by a trailer 10, with the goods being loaded and unloaded in/from the trailer 10 at a loading dock 12. The trailer 10 can be unloaded immediately upon arrival at the loading dock 12 or they may be parked for a while, even for days, weeks, or months, before loading/unloading. During travel to the loading dock 12 or while parked, the trailer 10 is subject to the ambient environmental conditions, most notably solar radiation from the sun, which tends to heat the interior of the trailer 10 relative to the ambient temperature. Since the trailer 10 is typically closed, unvented, and many trailers have metal walls that absorb the solar radiation, the trailer 10 effectively functions like an oven and the sun’s radiation can easily heat the interior of the trailer above 130 °F, and even beyond 150 °F depending on the ambient temperature. Such high temperatures inside the trailer 10 create a difficult environment, and potentially a health risk, for those loading/unloading the trailer 10, especially when the trailer 10 is loaded/unloaded by hand, as compared to a forklift or similar machine.

A dock fan assembly 14 as described in this description is well suited for reducing the temperature of the air within the trailer 10 toward or to the ambient air temperature. While the dock fan assembly 14 can be used to provide evaporative cooling for people in the trailer 10, the dock fan assembly 14 is primarily intended to exchange the heated air in the trailer 10 with ambient air to quickly reduce the internal air temperature of the trailer 10 close to or at the ambient temperature. The dock fan assembly 14 does this very quickly, within a few minutes to less than a minute, which can be as fast or faster than the time it takes for the loading/unloading to begin after opening of the trailer 10. To those loading/unloading the trailer 10, this is essentially, for all practical purposes, an “instant” cooling of the interior of the trailer 10 to the ambient temperature.

The rate at which the air in the trailer 10 can be exchanged with ambient air is a function of the volumetric flow rate of the fan and the volume of the trailer 10, ignoring for now the presence of goods in the trailer 10 that will reduce air volume in the trailer 10 and/or interfere with the flow of air in the trailer 10. For purposes of this description, unless stated otherwise, it should be assumed that an empty trailer 10 is being described for consistency. However, the presence of goods within the trailer 10 will reduce the volume of air that needs to be exchanged with the ambient air, and, all things being equal, will reduce the time it takes to exchange the air in the trailer 10 with an equal volume of ambient air. However, the presence of goods within the trailer 10 can interfere with the circulation air flow paths, which may increase the time it takes to exchange the trailer 10 air with ambient air and/or leave pockets of non-exchanged air.

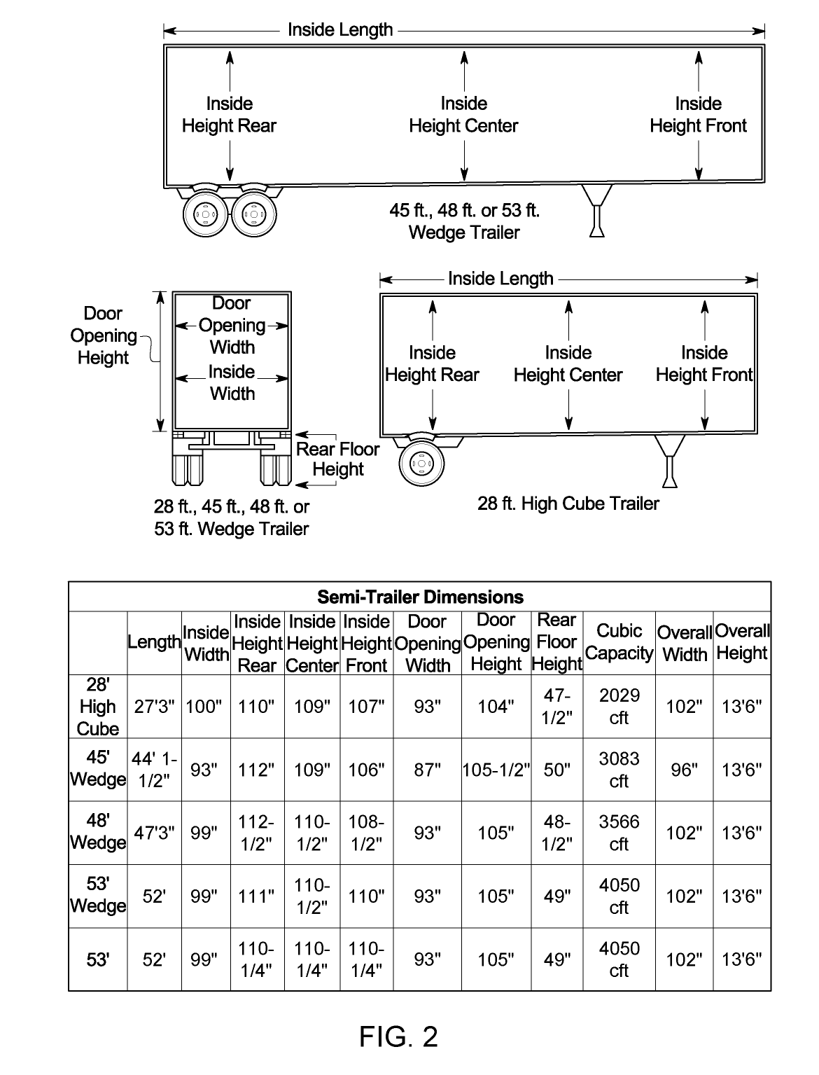

To understand the difficulties of providing a dock fan assembly 14 for exchanging air in the trailer 10, 10, it is useful to understand the physical constraints of the trailer/dock environment. Referring to FIG. 2, while a variety of truck/trailer combinations and dock configurations do exist, standard sizes have arisen. FIG. 2 is an exemplary listing of some semi-trailer dimensions. It should be understood that many other size trailers exist, and this list is not meant to be exhaustive. It is merely meant to be informative. Also, the trailers need not be limited to a semi-trailer configuration, but can also include box trucks, vans, and container trucks, to name a few others. With a container truck, the shipping container forms the trailer. Regardless of the trailer type, the dock fan assembly 14 can be used to exchange the trailer air with ambient air.

Currently, the maximum trailer door opening dimensions for the most common type of semi-trailer has a width, Tw, around 93 inches, and a height, Th, around 105 inches, resulting in a trailer door opening 16 of 93” x 105” or 7.75 feet (ft) by 8.75 ft.

Docks 12, like trailers 10, are built in a variety of sizes. Not surprisingly, dock door openings 18 have standardized around the maximum trailer door opening 16. Typical dock door openings 18 have a width, Dw, of between 7.5 ft and 10 ft and a height, Dh, of 8 ft to 10 ft, with a standard width of 9 ft and a standard height of 10 ft.

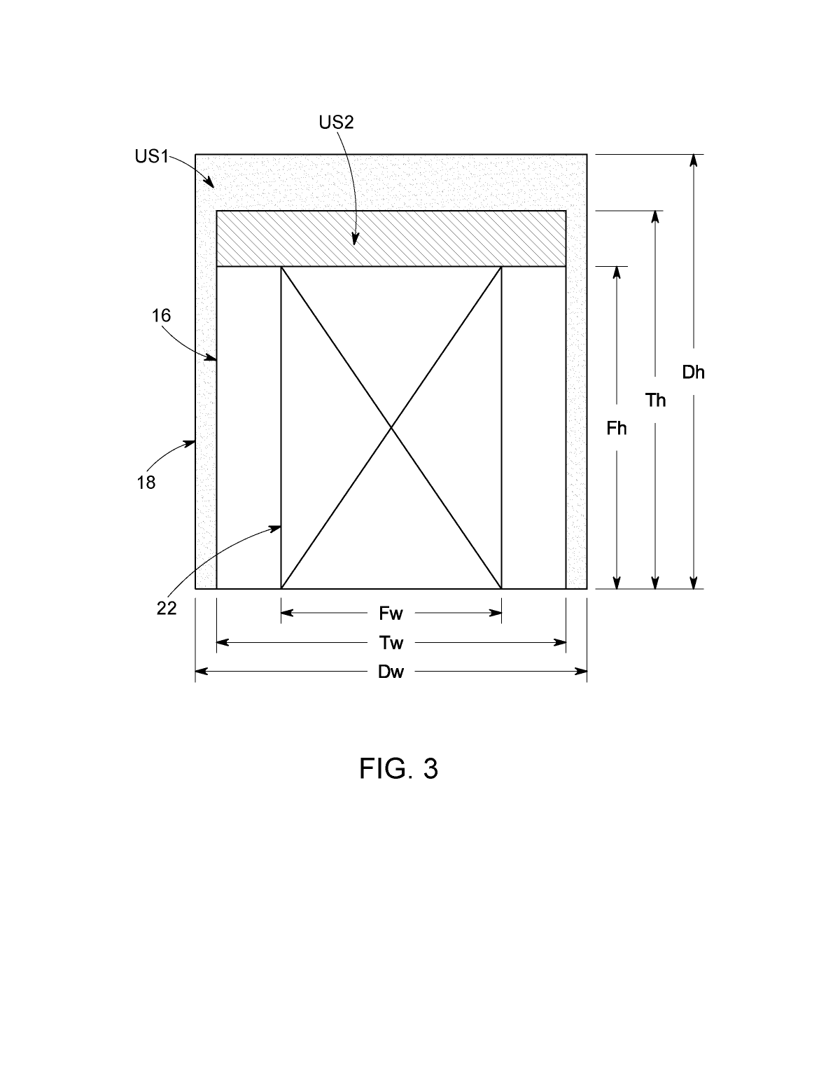

FIG. 3 illustrates an overlay of a trailer door opening 16 of 7.75 ft by 8.75 ft and a dock door opening 18 of 9 ft by 10 ft when the trailer 10 is backed up to and centered with the dock door opening 18. As can be seen, this leaves a usable perimeter of about 8” on each side of the trailer door opening 16 and about 16” along the top of the trailer door opening 16. The usable perimeter defines a first useful space, US1, (shaded with dots) for use by the dock fan assembly 14, which should be out of the way of the trailer 10.

FIG. 3 further illustrates a standard sized forklift 22, located within the trailer door opening 16, and illustrated as a rectangle with an “X”. The forklift 22 has a typical height, Fh, of 7 ft and a typical width, Fw, of 5 ft. During loading/unloading, the forklift 22 moves laterally across the trailer 10 removing goods from the trailer 10. Thus, operationally, there is no “extra” lateral room associated with a standard sized forklift 22. However, the forklift 22, at 7 ft tall, does define a second useful space, US2, between the top of the forklift 22 and the top of the trailer door opening 16. The second useful space US2 is about 1 ft tall and as wide as the trailer door opening 16. This second useful space US2 provides an area for use by the dock fan assembly 14.

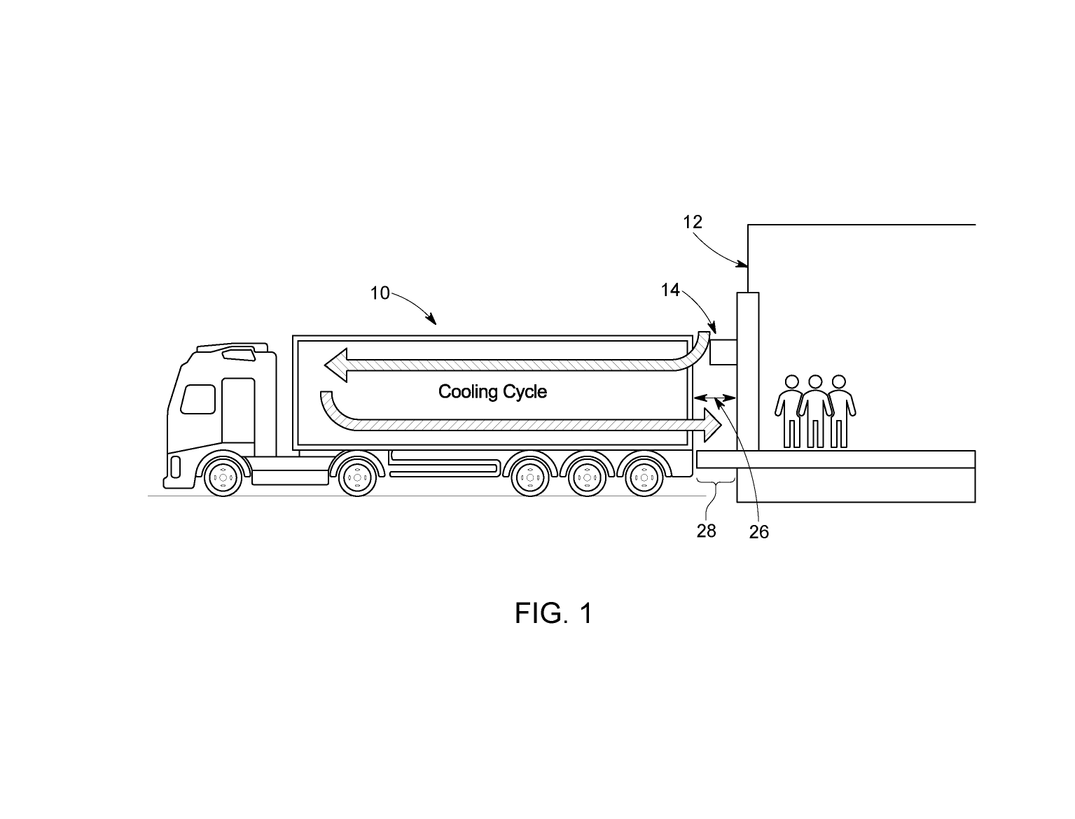

Another useful space for the dock fan assembly 14 is the gap 26 (FIG. 1) formed between the exterior of the dock door and the trailer door. The gap 26 typically exists because rarely is a trailer backed up into contact with the dock door opening 18. Typically, the dock 12 has an extension 28 that prevents the trailer 10 from making contact with the dock door opening 18. The standard gap 26 is about 6-12 inches and extends about the periphery of the trailer 10. The gap 26 is normally constant unless one of the trailer door opening 16 or dock door opening 18 is at an angle to the other.

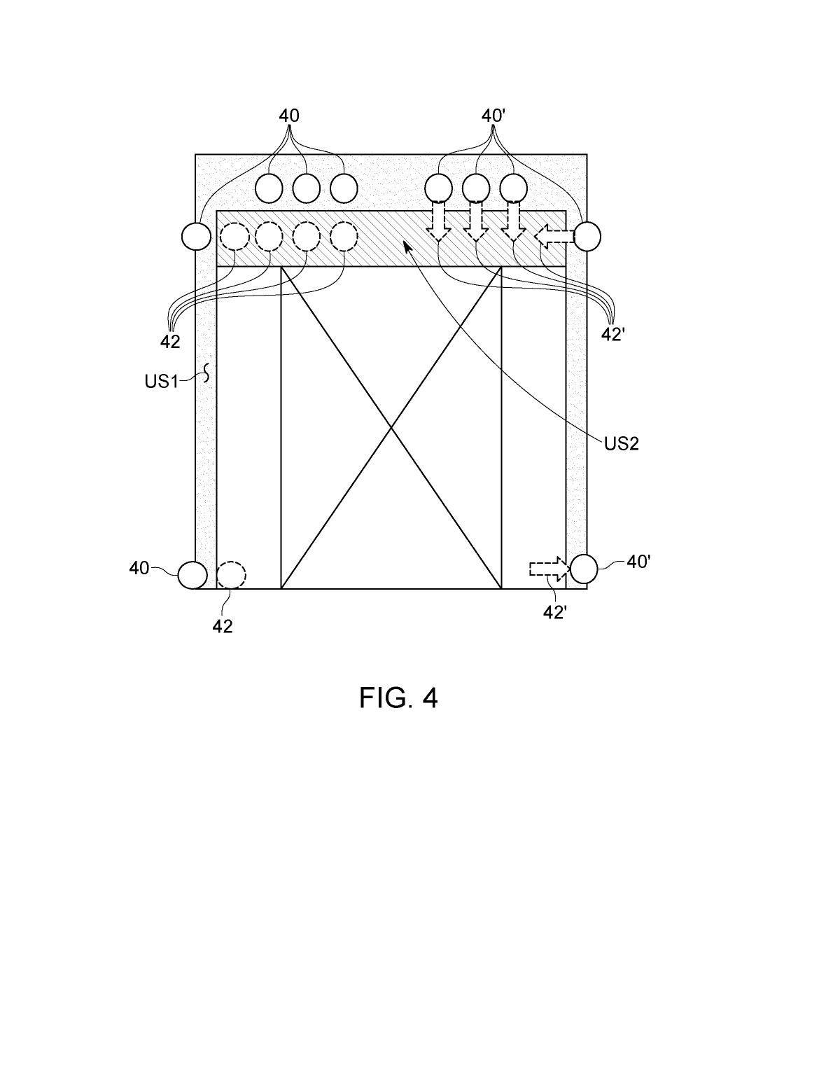

FIG. 4 illustrates various locations of fan 40 associated with the dock fan assembly 14. It should be noted that FIG. 4 illustrates the vertical positioning of the fan 40 relative to the dock door opening 18, trailer door opening 16, and forklift 22, but does not illustrate the horizontal positioning, that is whether the fan 40 is outside, within, or inside the dock door opening 18. For the description of FIG. 4, the fan can be at any desired horizontal positioning, even within the gap 26.

The dock fan assembly 14 can have one or more fans 40. The fans 40 can be movably or fixedly mounted relative to the dock door opening 18. The fans 40 can be located exteriorly or interiorly relative to the dock door opening 18. When the fans 40 are movably mounted relative to the dock door opening 18, they can be mounted to movable brackets connected to the building structure forming the dock door opening 18 and/or to a wheeled chassis, e.g. a dolly, or a cart, that can be moved into place. When the fans 40 are fixedly mounted relative to the dock door opening 18, they can be mounted by a suitable bracket or brackets to the building structure forming the dock door opening 18.

Regardless of the type of mounting (fixed or movable), the fans 40 can be safely located in the first usable space US1 as this will keep the fans 40 out of the way during the loading/unloading of the trailer 10. From the first usable space US1, if the fans 40 are fixedly mounted, they can be oriented such that their airflow is emitted into the trailer door opening 16. While not shown, it is possible for the fans 40 to be mounted within the second usable space US2, which is still out of the way of normal loading/unloading operations, but this does increase the chance the fans 40 might be contacted during loading/unloading.

Alternatively, the fans 40 can be movably mounted such that they can move into and out of the trailer door opening 16. The moved position is illustrated by the fans 42 shown in dashed lines. If the fans 40 are to be moved into the trailer door opening 16, at least temporarily while loading/loading, the fans 40 can be moved into the second usable space US2, where there is less likelihood they will be in the way during the loading/unloading. The fans 40 can be moved once or multiple times during loading/unloading as needed.

FIG. 4 further illustrates an alternative fan 40’, which unlike the fan 40, is not moved into the second usable space US2. Instead the fan 40’ has a moveable element 42’, such as a moveable conduit, that is moved or extended into the second usable space US2. The moveable conduit can be a flexible/expandable tube, or a telescoping tube, for example. The movement of the moveable conduit can be actuated by the flow of air through the fan 40’, which simplifies the mounting hardware needed to secure the fan 40’ to the surrounding building structure. The alternative fan 40’ can be used in place of the fan 40. For simplicity’s sake, this description will reference only fan 40 with it being understood that alternative fan 40’ can be substituted or used in combination with the fan 40 and vice versa. Unless otherwise stated, all descriptions of fan 40 apply to fan 40’.

While FIG. 4 primarily illustrates the fans 40 located along top of the dock door opening 18, the fans 40 can be located anywhere along the perimeter of the dock door opening 18. The fans 40 can be a single fan 40 or an array of two or more fans 40. The array of fans 40 can extend all the way across the top of the dock door opening 18, along one or both sides of the dock door opening 18, or both. The array of fans 40 can extend around the entire perimeter of the trailer door opening 16. For example, along the sides of the trailer door opening 16, the fans 40 can reside in the first useful space US1, and along the top of the trailer door opening 16 the array of fans 40 can extend along either or both of the first useful space US1 or second useful space US2. This array of fans 40 forms an inverted U-shape about the trailer door opening 16.

In another configuration, the fans 40 can be a cooperative pair of fans 40. A cooperative pair of fans 40 could be located at each of the upper corners of the dock door opening 18 or at any other location. A single fan 40 could be located at each of the upper corners of the dock door opening 18.

The fans 40 can also be located, as shown, at the bottom of the dock door opening 18. While these fans 40 can flow air into the trailer door opening 16, they can also be used to withdraw air out of the trailer door opening 16. For completeness, all of the fans 40 can be reversible and used to flow air in or withdraw air out of the trailer 10 as desired as a group of fans or on an individual fan basis.

The combination of fans 40 flowing air into the upper part of the trailer door opening 16 with fans 40 withdrawing air from the bottom of the trailer door opening 16 can help achieve the air circulation flow path illustrated by the arrows in FIG. 1. In this manner, any arrangement of fans 40 can use any combination of fans 40 that flow air into the trailer door opening 16 and fans 40 that withdraw air from the trailer door opening 16. While a top to bottom flow is illustrated, a side-to-side, crisscross or other flow paths are contemplated. Since hot air tends to rise, it is contemplated that the more efficient approach is to flow air into the upper part of the trailer door opening 16 and withdraw air out from the lower part of the trailer door opening 16.

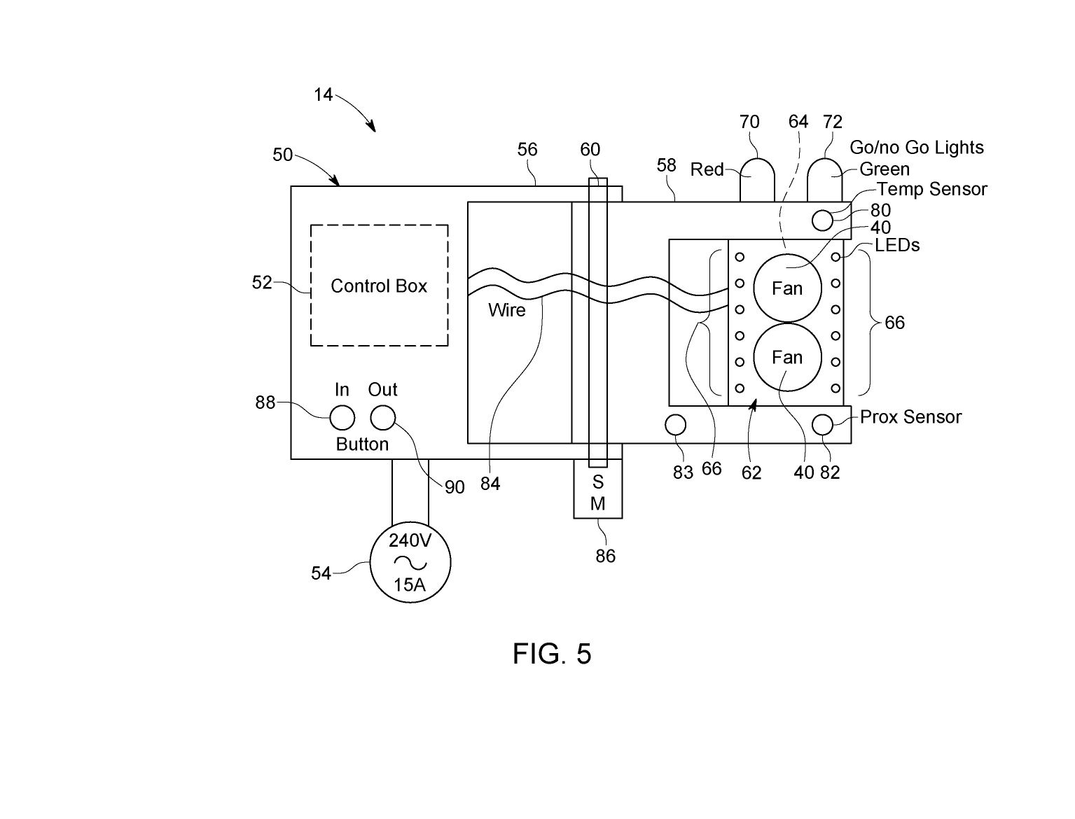

FIG. 5 illustrates an exemplary dock fan assembly 14 having two fans 40. The dock fan assembly 14 further includes a control box 50 in which resides a controller 52, for controlling the operation of the dock fan assembly 14. The controller 52 is coupled to a suitable power supply 54 such as, for example, a traditional electric utility system or a battery system.

The control box 50 includes a yoke 56 to which a swing arm 58 is pivotally attached to form a first pivot axis 60. The swing arm 58 supports a fan chassis 62, which carries the two fans 40. The fan chassis 62 is illustrated as being pivotally connected to the swing arm 58 to define a second pivot axis 64.

A light, in the form of an LED array 66 can be carried by the fan chassis 62. The LED array 66 can be two arrays of multiple LEDs on opposite sides of one or both of the two fans 40, as illustrated, or they can be just a single LED, a single LED on each side of the fans 40, or an array of LEDs encircling the fans 40. The LEDs can be a single color, such as white, or multiple colors, such as red, green, blue, which can be used to form any color. The LED array can be used for illumination, indication, or both.

Indicators in the form of a red indicator light 70 and green indicator light 72 are also carried by the swing arm 58. The indicator lights 70, 72 can be used to indicate when the air in the trailer is exchanged (green indicator light 72 is illuminated) or not (red indicator light 70 is illuminated). For example, when the fans 40 are initially actuated, the red indicator light 70 is illuminated until exchange is completed and then the green indicator light 72 is illuminated while the red indicator light 70 is turned off.

As an alternative, the LED arrays 66 can be used as indicators as well in place of or supplemental to the red/green lights 70/72. As the LEDs of the LED array 66 may be individually controlled, one or more of them may be used as an indicator while the others are used for illumination, or all of them may be used for indication.

Various sensors for the operation of the dock fan assembly 14 can be carried by the control box 50, yoke 56, swing arm 58 or fan chassis 62. Such sensors include, without limitation, a temperature sensor 80 and a door sensor 82. The temperature sensor can be a simple thermometer or infrared sensor or it can be more complex, such as a camera 83 having thermal imaging capability, including the possibility of Artificial Intelligence (AI) control. The camera 83 may further have visual image processing capability. When a camera and suitable processing software is used, it may also be used to detect the presence of people and/or the arrangement of the goods within the trailer. The detection of people and goods can be used to control the operation of the dock fan assembly 14. These may also be accomplished by the AI control.

Similarly, the door sensor 82 can be a simple proximity sensor that senses whether the dock door, the trailer door, or a combination thereof is open or closed by sensing its physical presence. The door sensor 82 can also be implemented with the camera 83 and suitable processing software to detect whether the dock door, the trailer door, or a combination thereof is open or closed. The same or different cameras 83 can be used for temperature detection and door detection.

A wiring harness 84 can provide power and/or data from the controller 52 to the fans 40, LED array 66, indicator lights 70, 72, and sensors 80, 82. Additionally, a motor 86, such as a stepper motor, can be used to rotate the swing arm 58 into and out of the trailer door opening 16. Actuators, in the form of press buttons 88, 90, labeled “In” and “Out” can be used to power the motor 86. When it is desired to deploy the fans 40, a user need only press the “Out” button 90 to drive the motor 86 to extend the swing arm 58. When it is desired to retract the fans 40, the user presses the “In” button 88 to operate the motor 86 and remove the fans 40 out of the trailer door opening 16. The “In” and “Out” positions can correspond to first usable space US1 and the second usable space US2, respectively. The buttons 88, 90 and motor 86 can also be controlled by the controller 52.

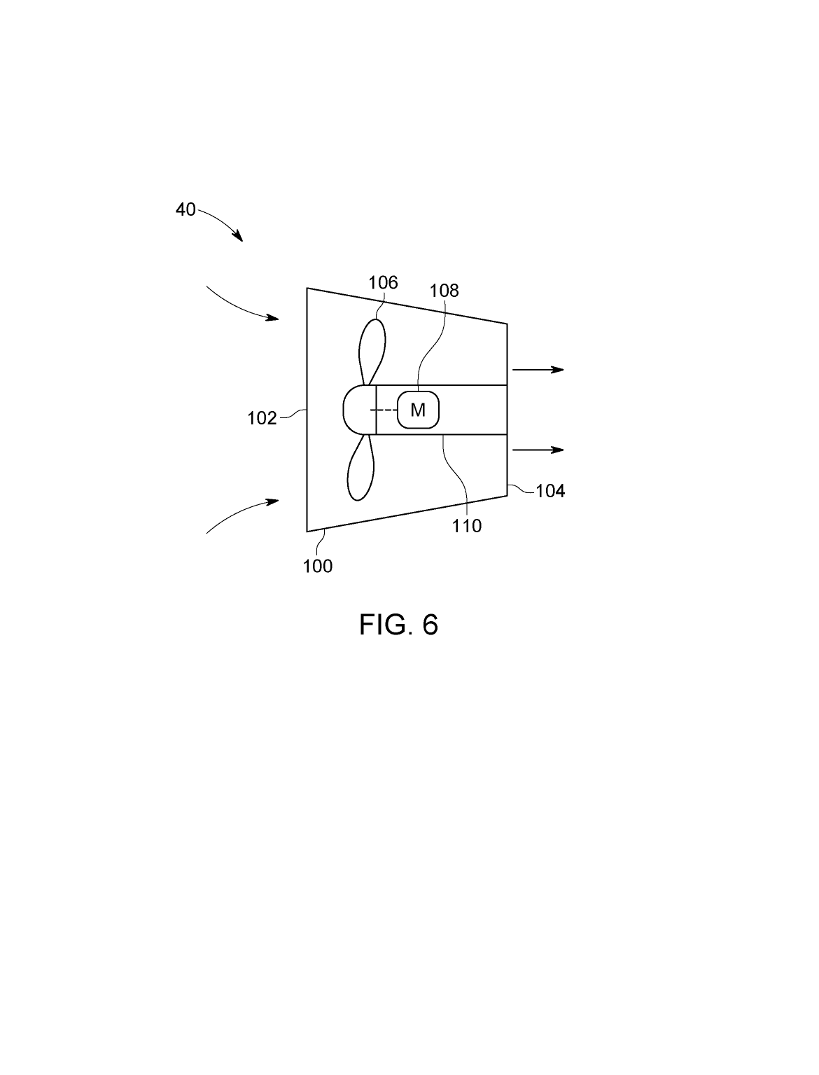

FIG. 6 illustrates an example of the fan 40, which has a housing 100 defining an inlet 102 and an outlet 104. Fan blades 106 are located within the housing 100 and rotatably driven by motor 108 located within a hub 110. The housing 100 is shaped in the form of a nozzle having a decreasing cross-sectional area from the inlet to the outlet to accelerate the air passing through the housing 100 and create a focused stream or jet of air emitted from the outlet, which is more capable of reaching the full depth of the trailer 10.

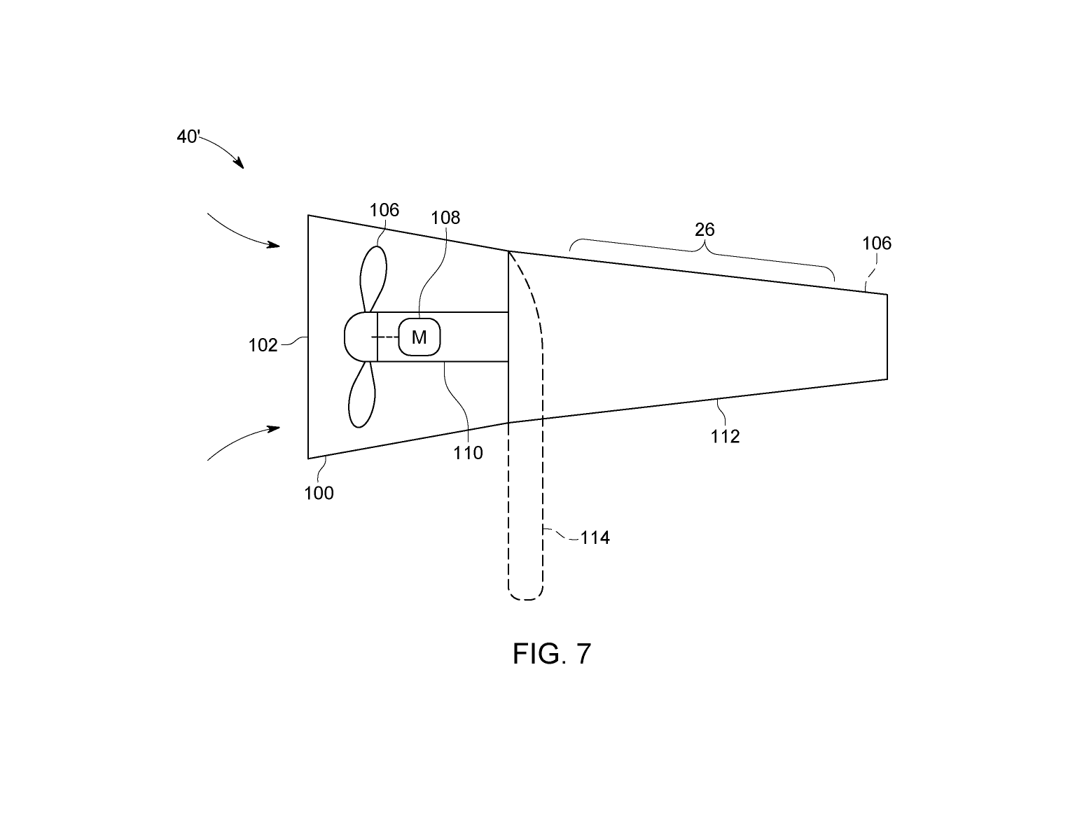

FIG. 7 illustrates an example of the fan 40’, which is suitable for spanning the gap 26 between the dock door opening 18 and the trailer door opening 16. The fan 40’, as illustrated, is identical to the dock fan 40, except that it includes an extension 112. As illustrated, the extension 112 is a flexible/expandable tube, which has a deflated state 114 illustrated with dotted lines, when the fan 40’ is not operating, and an inflated state 116, when the fan 40’ is operating. The flexible/expandable tube is selected to be of sufficient length to span the gap 26 in the inflated state.

The length of the flexible/expandable tube can be selected to be of any desired length, assuming rotation of the fan blades 106 can inflate it, and extend any desired depth toward or into the trailer 10. When more than one fan 40’ is used, the same or different length flexible/expandable tube can be used. For example, when different length flexible/expandable tubes are used, a longer flexible/expandable tube may be provided at the upper corners of the trailer door opening 16, with shorter flexible/expandable tubes used in the upper center area of the trailer door opening 16. This example is not limiting as any imaginable and useful combination of flexible/expandable tube lengths can be used.

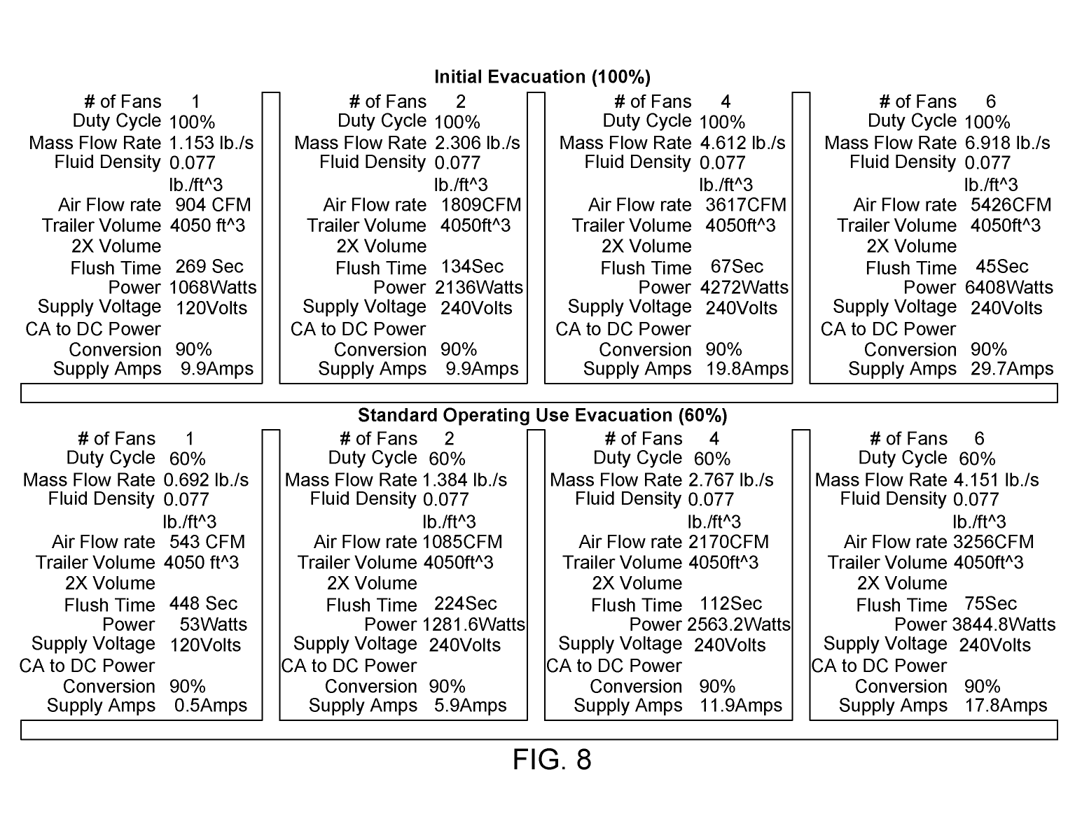

Referring to FIG. 8, the volumetric flow rate and the number of fans 40 will generally be selected while considering the space constraints around the dock door opening 18 for the fans 40, anticipated sizes of the trailer 10, and the desired time for a full exchange of air in the trailer 10. For example, the largest trailers currently in use have a volume of approximately 4050 cubic feet (ft³). A fan with a volumetric flow rate of 904 cubic feet per minute (CFM) is of a suitable size for use in one or both of the first usable space US1 and/or second usable space US2. Such a fan 40operating at 100% duty cycle can exchange the air two times (2X) within a 4050 ft³ trailer in 269 seconds, which is a little over 4 minutes. A 2X exchange of air has been found to sufficiently reduce the air temperature within the trailer 10 to or at or near the ambient air.

If faster times are desired, additional fans 40 may be used. As can be seen, when two fans 40 are used, the time for a 2X exchange of air drops to 134 seconds, for four fans 40, the time for a 2X exchange drops to 67 seconds, and for six fans 40, the time for a 2X exchange drops to 45 seconds. Notably, these times are for an empty trailer. These times will likely be faster as more goods are loaded in the trailer 10, unless the goods block air circulation.

If it is desired not to operate the fans 40 at 100% duty cycle, such as operating the fans 40 at a lower noise level, this can be done with a corresponding increase in the time it takes for a 2X exchange. As is seen in FIG. 8, when the fans 40 are run at 60% duty cycle, the corresponding times for 1, 2, 4 and 6 fans 40 are: 448 seconds, 224 seconds, 112 seconds, and 75 seconds, respectively.

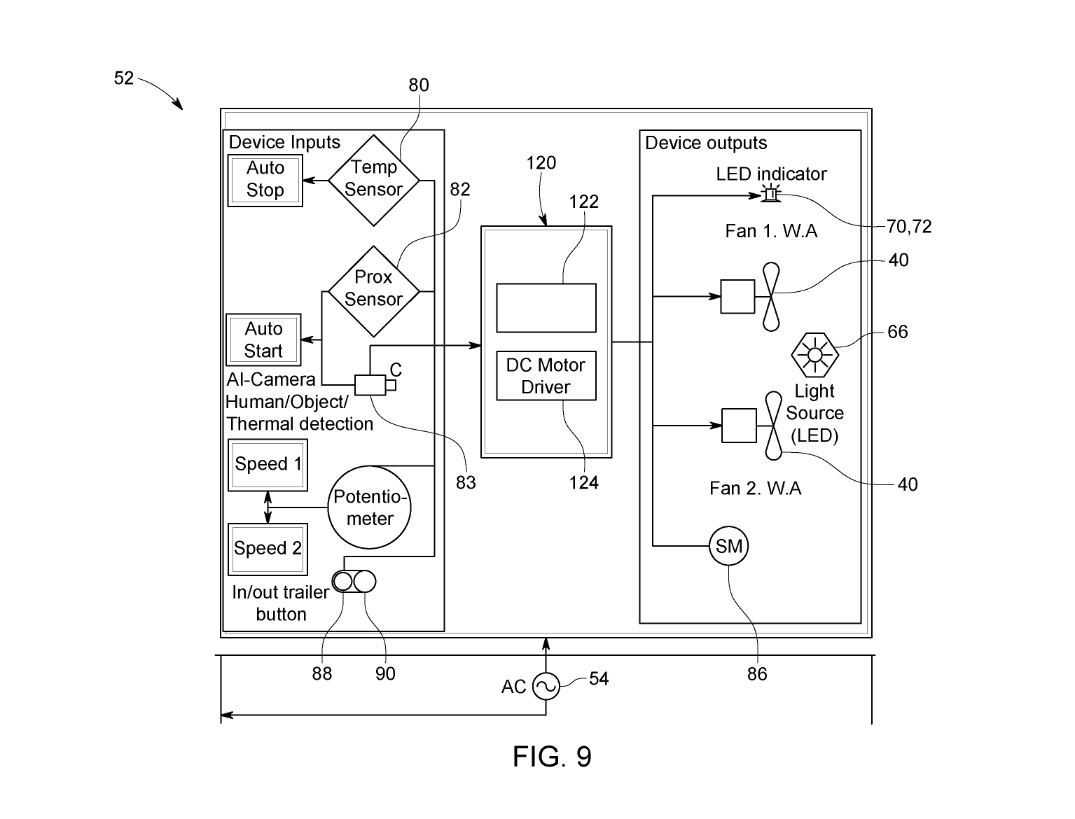

FIG. 9 illustrates an exemplary controller 52 for operating the dock fan assembly 14. The controller 52 includes a computer processor 120 running suitable software 122, including a motor driver 124, to operate the fans 40. The processor 120 receives as inputs the In/Out buttons 88/90 and sensors, such as the temperature sensor 80, door sensor 82, and camera 83. These inputs are processed by the software 122,124 to control the operation of the fans 40.

An example of one possible operation by the controller 52 begins with the actuation of the Out button 90, which is processed by the processor 120 to actuate the motor 86 and extend the fans 40 from the first usable space US1 to the second usable space US2. The door sensor 82 or the camera 83 provides input to the processor 120 of whether the trailer door is open. When the trailer door is open, the processor can automatically start the fans 40. Prior to or at the start of the fans 40, the red indicator light 70 can be illuminated to indicate the temperature in the trailer 10 has not yet been reduced and/or the air has not been desirable exchanged. The processor 120 can continue the operation of the fans 40 until either 1) after the passage of a predetermined amount of time, or 2) a predetermined temperature is reached as indicated by either the temperature sensor 80 or the camera 83. At that time, the red indicator light 70 is turned off and the green indicator light 72 is turned on, which indicates the desired cooling or air exchange is complete, and the fans 40 can be powered off. During the first cooling or air exchange of the trailer 10, it is contemplated the fans 40 will be run at 100% duty cycle to affect the cooling or air exchange as quickly as possible. However, this need not be the case as the fans 40 can be operated at any duty cycle.

At this time, depending on the programming, the processor 120 can automatically actuate the motor 86 to return the fans 40 to the first usable area US1. Alternatively, the processor 120 can be programmed to operate in a standby mode, where the processor 120 monitors the temperature of the air in the trailer 10, and, when the air temperature increases to a certain temperature or by a certain number of degrees, the processor 120 activates the fans 40 once again. The fans 40 can be run for a predetermined period of time, until a desired temperature inside the trailer 10 is reached, or until a desired temperature drop inside the trailer 10 is reached. The processor 120 can continue this sensed operation of the fans 40 as long as the trailer is being loaded/unloaded. The processor can also control the duty cycle of the fans 40.

The processor 120 can further be programmed to continuously run the fans 40 after the initial cooling or air exchange. The continued running of the fans 40 will provide a cooling air flow for those loading/unloading the trailer while retarding a rising air temperature in the trailer 10. It is contemplated that the continued running of the fans 40 will be at a reduced volumetric flow rate, but that need not be the case. The continued running of the fans 40 can be automatically stopped when the processor 120 receives an input from the door sensor 82 or camera 83 that the trailer door opening 16 is closed or the “In” button is actuated indicating the loading/unloading is complete.

If different types of fans 40, 41 are used, the processor can be programmed to run only the fans 40 that are more likely to provide a cooling air flow, such as a more dispersed air flow and/or the location of the fans 40. The fans 41, with their extendable nozzle, may provide a jet of air that mostly bypasses those loading/unloading the trailer. Some of the fans 40 may be specifically designed and/or located to provide a cooling air flow to the people loading/unloading the trailer. For example, fans 40 across the second usable area US2 may have a higher volumetric flow rate or have a more focused jet of air to help cool the trailer 10 or exchange the air, while another set of fans 40 along the vertical sides of the trailer 10 in the first usable space US1 may have a lower volumetric flow rate and/or have a more diffuse flow stream to provide more evaporative cooling for those loading/unloading the trailer 10.

The processor 120 can also be programmed such that if the trailer door opening 16 is closed while the fans 40 are running, or not running, the processor automatically determines the loading/unloading is complete and the fans 40 are shut off and the arm is retracted.

The processor 120 can further be programmed to receive the input of the camera 83 and determine which fans 40 might be blocked by the goods. The processor 120 can selectively actuate those fans that will not be blocked or that have the least amount of blockage. Similarly, the processor 120 can be programmed to use the camera input to determine a likely circulation path through the goods in the trailer 10 and actuate the fans 40 necessary to circulate the air along the determined flow path. In the case where the fans 40 are reversible, the processor can not only selectively actuate the desired fans 40, it can also control the direction of flow for the fan 40. For example, say a tall object is blocking the center of the trailer door opening 16, a fan 40 in the upper left corner in the second useful area US2 could be actuated to flow air into the trailer 10 while a fan 40 in the upper right corner of the second useful area US2 could be actuated to withdraw air out of the trailer 10 to create a circulation flow path around the tall object.

In another implementation, there can be an array of fans 40 about all of the first and second usable area US1, US2 and the controller 52 could acuate any fan 40 in the array and any desired flow direction to accomplish a desired circulation path.

Throughout this description, relative references, like “about”, “similar”, “substantially similar”, or “substantially equal”, etc. are used. These terms are meant to references values or conditions that are for practical purposes are the same even though they may not be literally equal. For example, in the comparisons between the ambient and trailer air temperatures, normally a few degrees difference, such as 5-10 degrees is practically the same for the expected environmental conditions. Alternatively a temperature difference of no greater than 5% or 10% at the most.

This written description uses examples to disclose the invention, including the best mode, and to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A method for exchanging air from a trailer, having a trailer door opening, located at a dock having a dock door opening, which is aligned with the trailer door opening, the method comprising: forming a circulation air flow path by flowing ambient air into the trailer opening with a first fan and withdrawing air from the trailer opening with a second fan; ceasing the flowing of ambient air and the withdrawing of trailer air upon the determination that the trailer air has been exchanged with ambient air.

The method of any preceding clause wherein the determination comprises operating the first fan and the second fan for a predetermined time period.

The method of any preceding clause wherein the predetermined time period is a function of the entire volume of the trailer.

The method of any preceding clause wherein the predetermined time period is a function of the empty volume of the trailer.

The method of any preceding clause wherein the empty volume is determined by a sensor.

The method of any preceding clause wherein the sensor is a camera providing an image of an interior of the trailer and a processor processing the image to determine the empty volume.

The method of any preceding clause wherein the determination comprises operating the first fan and the second fan until the trailer air temperature is substantially the same as the ambient air temperature.

The method of any preceding clause wherein one or both of the ambient air temperature and the trailer air temperature is sensed with a sensor.

The method of any preceding clause wherein the sensor is at least one of a thermometer, infrared sensor, or camera.

The method of any preceding clause wherein the ambient air temperature is a provided air temperature from a weather service.

A dock fan assembly for flowing ambient air to a trailer door opening located adjacent a dock door opening to exchange the trailer air with ambient air, the dock fan assembly comprising: a fan flowing ambient air into the trailer door opening; and an indicator indicating when the exchange of air is complete.

The dock fan assembly of any preceding clause wherein the indicator illuminates at a first color when the exchange of air is complete.

The dock fan assembly of any preceding clause wherein the indicator illuminates at a second color, different from the first color, when the exchange is not complete.

The dock fan assembly of any preceding clause having an array of lights providing illumination into the trailer door opening.

The dock fan assembly of any preceding clause wherein the array of lights have at least a subset of lights forming the indicator.

The dock fan assembly of any preceding clause further comprising a proximity sensor.

The dock fan assembly of any preceding clause further comprising a temperature sensor.

The dock fan assembly of any preceding clause further comprising a camera viewing the trailer door opening.

The dock fan assembly of any preceding clause wherein the fan comprises a nozzle directed toward the trailer door interior.

The dock fan assembly of any preceding clause wherein the nozzle is a converging nozzle.

The dock fan assembly of any preceding clause wherein the nozzle is a flexible or expandable conduit movable between a non-extended and an extended state.

The dock fan assembly of any preceding clause wherein in the extended state, a portion of the nozzle extends through the trailer door opening.

The dock fan assembly of any preceding clause where in the trailer door opening is separated from the dock door opening by a gap, and in the extended state, the nozzle spans the gap.

A dock fan assembly for flowing ambient air to a trailer door opening located adjacent a dock door opening to exchange the trailer air with ambient air, the dock fan assembly comprising: a control box having a housing, which defines an interior; an arm movably mounted to the control box for movement between a retracted position and an extended position; a drive coupled to the arm and driving the arm between the retracted position and the extended position; a fan carried by the arm; at least one sensor carried by the arm; at least one indicator carried by the arm; and a controller located in the interior and operably coupled to the drive, fan, sensor, and indicator.

The dock fan assembly of any preceding clause wherein in the drive is a motor that rotates the arm between the retracted position and the extended position.

The dock fan assembly of any preceding clause wherein the fan comprises an extendable nozzle.

The dock fan assembly of any preceding clause wherein the at least one sensor comprises at least one of a temperature sensor, proximity sensor, or camera.

The dock fan assembly of any preceding clause wherein the at least one indicator comprises a light that illuminates a status of the air exchange.

The dock fan assembly of any preceding clause wherein the light comprises an LED array that provides illumination as well as indication.

The dock fan assembly of any preceding clause wherein the nozzle is extendable between a non-extended and an extended state.

The dock fan assembly of any preceding clause wherein in the extended state, a portion of the nozzle extends through the trailer door opening.

The dock fan assembly of any preceding clause wherein the trailer door opening is separated from the dock door opening by a gap, and in the extended state, the nozzle spans the gap.

The dock fan assembly of claim 30 wherein the flowing of air through the nozzle extends the nozzle.

What is claimed is:

1. A dock fan assembly for flowing ambient air to a trailer door opening located adjacent a dock door opening to exchange the trailer air with ambient air, the dock fan assembly comprising:
a fan flowing ambient air into the trailer door opening; and
an indicator indicating when the exchange of air is complete.

2. The dock fan assembly of claim 1 wherein the indicator illuminates at a first color when the exchange of air is complete.

3. The dock fan assembly of claim 2 wherein the indicator illuminates at a second color, different from the first color, when the exchange is not complete.

4. The dock fan assembly of claim 3 having an array of lights providing illumination into the trailer door opening.

5. The dock fan assembly of claim 4 wherein the array of lights have at least a subset of lights forming the indicator.

6. The dock fan assembly of claim 1 further comprising a proximity sensor.

7. The dock fan assembly of claim 1 further comprising a temperature sensor.

8. The dock fan assembly of claim 1 further comprising a camera viewing the trailer door opening.

9. The dock fan assembly of claim 1 wherein the fan comprises a nozzle directed toward the trailer door interior.

10. The dock fan assembly of claim 9 wherein the nozzle is a converging nozzle.

11. The dock fan assembly of claim 10 wherein the nozzle is a flexible or expandable conduit movable between a non-extended and an extended state.

12. The dock fan assembly of claim 11 wherein in the extended state, a portion of the nozzle extends through the trailer door opening.

13. The dock fan assembly of claim 11 where in the trailer door opening is separated from the dock door opening by a gap, and in the extended state, the nozzle spans the gap.

14. A dock fan assembly for flowing ambient air to a trailer door opening located adjacent a dock door opening to exchange the trailer air with ambient air, the dock fan assembly comprising:
a control box having a housing, which defines an interior;
an arm movably mounted to the control box for movement between a retracted position and an extended position;
a drive coupled to the arm and driving the arm between the retracted position and the extended position;
a fan carried by the arm;
at least one sensor carried by the arm;
at least one indicator carried by the arm; and
a controller located in the interior and operably coupled to the drive, fan, sensor, and indicator.

15. The dock fan assembly of claim 14 wherein in the drive is a motor that rotates the arm between the retracted position and the extended position.

16. The dock fan assembly of claim 15 wherein the at least one sensor comprises at least one of a temperature sensor, proximity sensor, or camera.

17. The dock fan assembly of claim 16 wherein the at least one indicator comprises a light that illuminates a status of the air exchange.

18. The dock fan assembly of claim 14 wherein the nozzle is an extendable nozzle that is extendable between a non-extended and an extended state.

19. The dock fan assembly of claim 18 wherein in the extended state, a portion of the nozzle extends through the trailer door opening.

20. The dock fan assembly of claim 19 wherein the trailer door opening is separated from the dock door opening by a gap, and in the extended state, the nozzle spans the gap.
